(19) United States
(12) Patent Application Publication
(10) Pub. No.: US 2018/0165265 A1
(43) Pub. Date: Jun. 14, 2018

(54) INDICATING PROPERTY INHERITANCE IN OBJECT HIERARCHIES

(71) Applicant: International Business Machines Corporation, Armonk, NY (US)

(72) Inventors: Sean P. Cox, San Francisco, CA (US); David G. Derk, Gibsonia, PA (US); Kevin L. Gibble, Tucson, AZ (US); Andres F. Holguin, Pembroke Pines, FL (US); James P. Smith, Redwood City, CA (US); Steven V. Voyk, Austin, TX (US); Martine B. Wedlake, Hillsboro, OR (US); Jean X. Yu, Austin, TX (US)

(73) Assignee: International Business Machines Corporation, Armonk, NY (US)

(21) Appl. No.: 15/373,399

(22) Filed: Dec. 8, 2016

(51) Int. Cl. G06F 17/24; G06F 3/0481; G06F 3/0484

(52) U.S. Cl. CPC G06F 17/245; G06F 3/04842; G06F 3/04817

(57) ABSTRACT

A method for indicating property inheritance in object hierarchies is disclosed. In one embodiment, such a method includes enabling a user to select an object in an object hierarchy. In response, the method displays a property sheet showing property values for the selected object. The property sheet shows a property value that is inherited from an object upstream from the selected object. The method provides, on the property sheet, an icon indicating a level in the object hierarchy from which the property value is inherited, and a label indicating a source object in the object hierarchy from which the property value is inherited. The label may, in certain embodiments, incorporate a name associated with the source object and link to a property sheet associated with the source object. A corresponding system and computer program product are also disclosed.

### BACKGROUND

### Field of the Invention

This invention relates to systems and methods for indicating sources of property inheritance in object hierarchies.

### Background of the Invention

VMware vSphere is a server virtualization platform that provides a platform for implementing and managing virtual machines (VMs) on a large scale. Also referred to as a cloud operating system or virtualized datacenter platform, VMware vSphere enables administrators to allocate application workloads on the most cost-effective computing resources available. VMware vSphere is actually a suite of related software products, namely the VMware ESX/ESXi hypervisor, a type 1 hypervisor that functions as a virtualization server; the VMware vCenter Server, which manages vSphere environments; the VMware vSphere Client, which is used to install and manage virtual machines through the hypervisor; and VMware VMFS, a file system component from VMware.

VMware vSphere organizes various entities (i.e., datacenters, host clusters, host systems, virtual machines, etc) into an inventory hierarchy. Each of these entities (also referred to herein as “objects”) may have various properties (e.g., names, statuses, capacities, etc.) associated therewith. The property values associated with these properties may be presented in property sheets viewable through the VMware vSphere Client. The vSphere Client, however, provides little if any mechanisms for simplifying property management across the inventory hierarchy. This typically means that an administrator must assign property values to significant numbers of individual objects, which can be a very time-consuming process.

In view of the foregoing, what are needed are systems and methods to enable objects in an inventory hierarchy to inherit property values from higher-level objects. This will ideally reduce the need to individually assign property values to significant numbers of down-level objects. Systems and methods are also needed to quickly and easily determine which higher-level objects are sources of inheritance for down-level objects. This will help administrators determine where in the inventory hierarchy property values should ideally be modified.

### SUMMARY

The invention has been developed in response to the present state of the art and, in particular, in response to the problems and needs in the art that have not yet been fully solved by currently available systems and methods. Accordingly, systems and methods are disclosed for indicating sources of property inheritance in object hierarchies. The features and advantages of the invention will become more fully apparent from the following description and appended claims, or may be learned by practice of the invention as set forth hereinafter.

Consistent with the foregoing, a method for indicating property inheritance in object hierarchies is disclosed. In one embodiment, such a method includes enabling a user to select an object in an object hierarchy. In response, the method displays a property sheet showing property values for the selected object. The property sheet shows a property value that is inherited from an object upstream from the selected object. The method provides, on the property sheet, an icon indicating a level in the object hierarchy from which the property value is inherited, and a label indicating a source object in the object hierarchy from which the property value is inherited. The label may, in certain embodiments, incorporate a name associated with the source object and link to a property sheet associated with the source object.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing an example of a computing system in which a system and method in accordance with the invention may be implemented;

FIG. 2 shows one example of an object hierarchy, in this example an object hierarchy in a vSphere virtualization environment;

FIG. 3 shows how property values may be inherited from higher level objects in the object hierarchy illustrated in FIG. 2;

FIG. 4 shows one embodiment of a property sheet to display property values associated with an object, as well as icons and labels for showing sources of object property inheritance; and

FIG. 5 shows various modules that may be used to implement a system and method in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer-readable storage medium (or media) having computer-readable program instructions thereon for causing a processor to carry out aspects of the present invention.

The computer-readable storage medium may be a tangible device that can retain and store instructions for use by an instruction execution device. The computer-readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer-readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer-implemented process, such that the instructions which execute on the computer, other programmable apparatus, or other device implement the functions/acts specified in the flowchart and/or block diagram block or blocks.

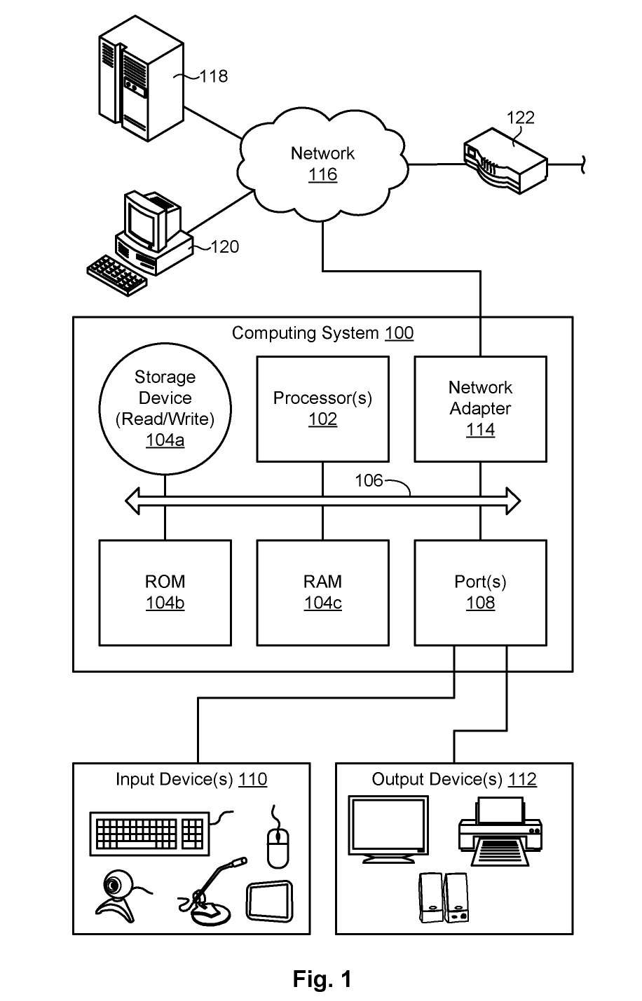

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented only by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

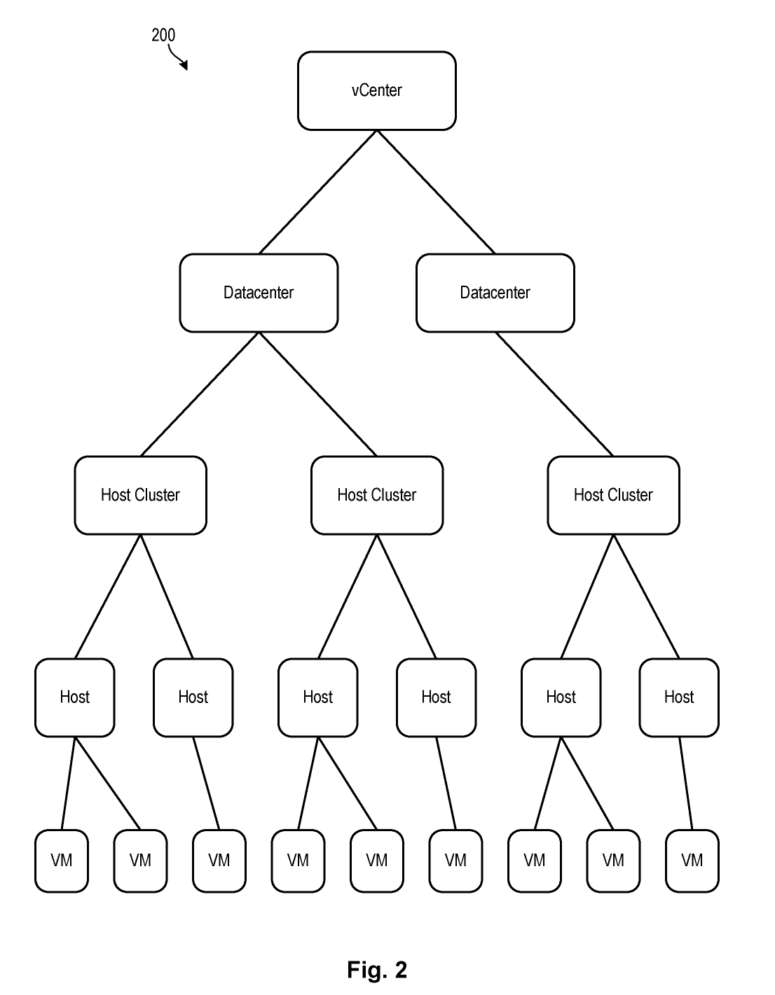

Referring to FIG. 2, as previously mentioned, products such as VMware vSphere organize objects into inventory hierarchies. FIG. 2 shows one example of an object hierarchy 200 created by a product such as VMware vSphere. As shown, a “vCenter” is the top-level object, followed by datacenters, host clusters, host systems, and virtual machines (VMs) in each successive level of the object hierarchy 200. In the illustrated embodiment, virtual machines are the lowest level objects. In most cases, the number of objects increases at each successive level in the object hierarchy 200. Thus, the datacenter objects will typically be more numerous than the vCenter objects, the host cluster objects will typically be more numerous than the datacenter objects, and so forth.

Each of the objects may have various properties (e.g., names, statuses, capacities, etc.) associated therewith. Each property in an object may be assigned a property value. Because an object hierarchy 200 may include many, many objects, and because the vSphere Client provides minimal functionality to simplify property management across objects in the object hierarchy 200, this typically results in an administrator having to assign property values to significant numbers of individual objects. This can be a time-consuming, laborious process.

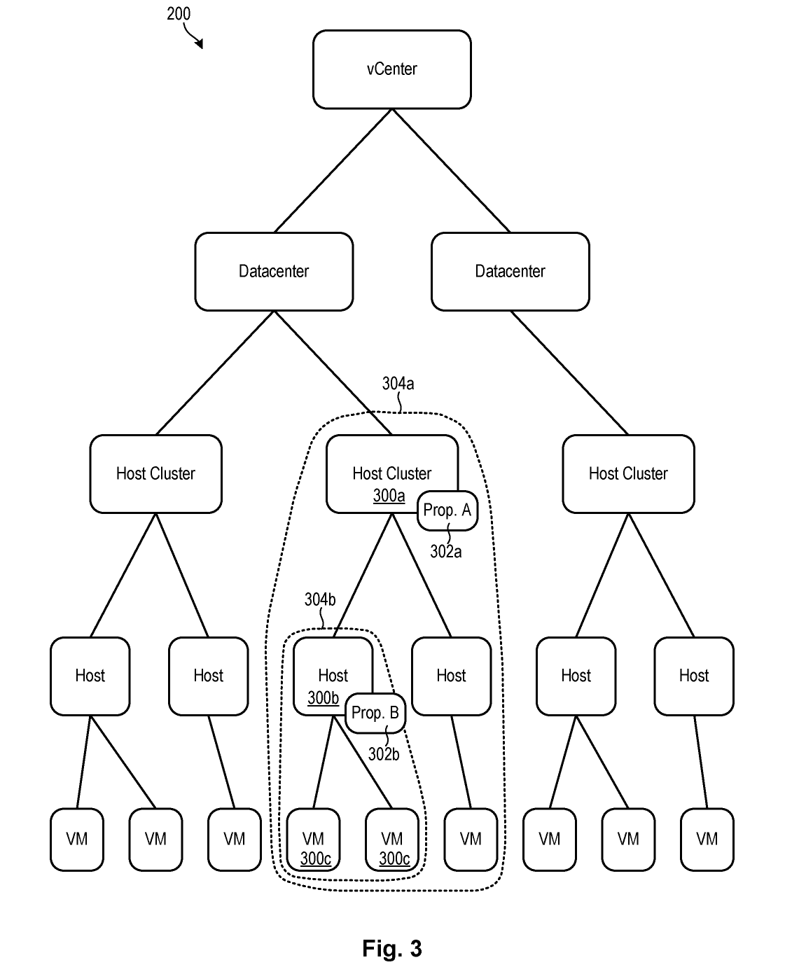

Referring to FIG. 3, in order to simplify property management across the object hierarchy 200, an inheritance scheme may be established wherein lower-level objects inherit property values from higher-level objects. This inheritance may, in certain embodiments, occur automatically without user intervention. For example, setting a property value for a property 302a in a host cluster object 300a may cause all objects below the host cluster object 300a (i.e., within the dotted line 304a) to inherit the property value. Similarly, setting a property value for a property 302b in the host system object 300b may cause all objects below the host system object 300b (i.e., within the dotted line 304b) to inherit the property value. Thus, some lower-level objects, such as the virtual machine objects 300, may have property values that are inherited from higher-level objects in the object hierarchy 200. In some cases, lower-level objects may inherit property values from multiple different objects at different levels in the object hierarchy 200. For example, as shown in FIG. 3, the virtual machines 300c may inherit property values from both the host cluster object 300a and host system object 300b.

In certain embodiments, override mechanisms may be provided for the inheritance scheme. For example, a property value set locally at an object 300 may override a property value inherited from a higher-level object 300. This locally-set property value may or may not be inherited by lower-level objects 300. In some embodiments, an option may be provided to prevent a property value set locally at an object 300 to be inherited by lower-level objects 300. In many cases, an object 300 in the object hierarchy 200 may have some property values that are inherited from higher-level objects 300, while having other property values that are set locally.

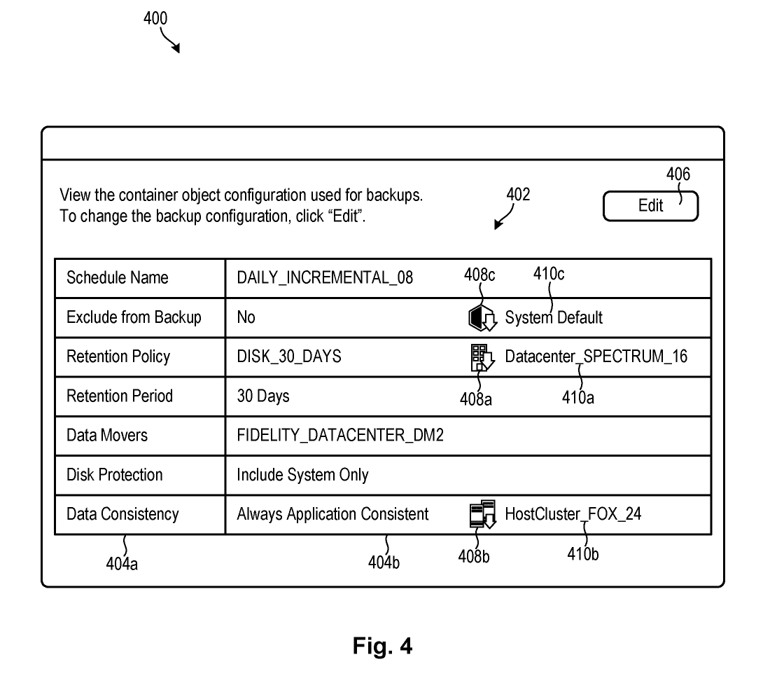

Referring to FIG. 4, in certain embodiments, an object 300 may be selected in the object hierarchy 200 in order to display a property sheet 400 for the selected object 300. This property sheet 400 may display properties and associated property values associated with the object 300. In the illustrated embodiment, the property sheet 400 is presented as a window in a graphical user interface, although the property sheet 400 is not limited to such an implementation. The property sheet 400 in the illustrated example includes a table 402 to list properties and associated property values. A first column 404a in the table 402 contains the property name and a second column 404b in the table 402 contains the property value. In the illustrated embodiment, an edit button 406 is provided on the property sheet 400 to enable an administrator to locally set the property values.

As previously mentioned, property values associated with an object 300 may in certain embodiments be inherited from higher-level objects. In certain cases, it may be difficult to ascertain where property values associated with an object 300 originated. In some cases, the property value may originate from higher-level objects while in other cases the property values may originate locally. Knowing the origin of property values may be important or helpful when modifying property values. For example, if a property value associated with an object 300 originated from a higher-level object, it may be better to modify the property value at the higher-level object instead of locally within the object 300 (which may, in certain cases, override the inheritance from the higher-level object). In some cases, an administrator may believe that a property value originated from a higher-level object but be unsure at which level in the object hierarchy 200 the property value originated. In such cases, the administrator may not be able to, with undue investigation, determine the object 300 in which the property value should ideally be modified.

In order to more easily determine the source of inherited property values, systems and methods in accordance with the invention may provide additional information in a property sheet 400 associated with an object 300. In certain embodiments, this information may be provided in the form of an icon 408 and label 410. The icon 408 may represent the level of the object hierarchy 200 from which the property value was inherited. Different icons 408 may be provided for different levels of the object hierarchy 200. The label 410, by contrast, may represent the actual object 300 in the object hierarchy 200 from which the property value was inherited. The label 410 may, in certain embodiments, contain a name or other unique identifier associated with the object 300. In certain embodiments, the absence of an icon 408 or label 410 may indicate that a property value was set locally at the object 300.

As shown in FIG. 4, additional space is provided in the column 404b to indicate if a property value originated from a higher-level object. For example, in the illustrated embodiment, the property “Retention Policy” has a property value of “DISK_30_DAYS.” As further shown in FIG. 4, an icon 408a and label 410a are provided in association with the property value. The icon 408a indicates that the property value originated from the datacenter level of the object hierarchy 200 and the label 410a contains the name of the datacenter object 300 (in this example “Datacenter_SPECTRUM_16”) from which the property value is inherited. In this embodiment, the arrow on the icon 408a is intended to indicate that the property value was inherited as opposed to being set locally.

As also shown in FIG. 4, the property “Data Consistency” has a property value of “Always Application Consistent.” An icon 408b and label 410b are provided in association with this property value. The icon 408b indicates that the property value originated from the host cluster level of the object hierarchy 200 and the label 410b contains the name of the host cluster object 300 (in this example “HostCluster_FOX_24”) from which the property value is inherited.

In certain embodiments, the label 410 may be linked to the object 300 from which the property value is inherited. In certain embodiments, clicking on the label 410 with a mouse pointer may navigate to a property sheet 400 associated with the identified higher-level object. In other or the same embodiments, hover-dialogues or pop-ups that display context information may be activated from the label/icon elements 408, 410, such as by mousing over or clicking on the elements 408, 410.

The ability to navigate to the property sheet 400 of a source object 300 may be useful when modifying property values. For example, if an administrator wishes to modify the property value “DISK_30_DAYS,” it may be better to modify this property value in the source object 300 (in this example the “Datacenter_SPECTRUM_16” object) as opposed to in a down-level object 300 that inherits the property value. Modifying the property value in the source object 300 will enable the property value to be propagated to objects 300 below the source object 300. On the other hand, if an administrator only wants to change a property value in a down-level object 300, the administrator may set or modify the property value locally. In certain embodiments, this may override the inheritance of this property value from a higher-level object.

Other uses for the icons 408 and labels 410 are also possible. For example, in certain cases, a property value may be inherited from systems or objects other than objects 300 in the object hierarchy 200. For example, the icon 408c may indicate that a property value is inherited from other software or systems. In this example, the label 410 indicates that the property value was established in accordance with a system default originating from other software or systems.

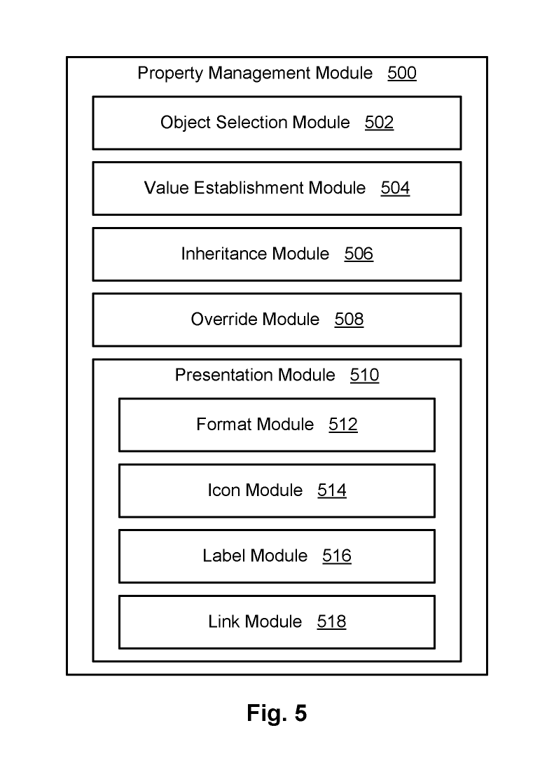

Referring to FIG. 5, in order to implement the functionality described above, a property management module 500 may be provided. This property management module 500 may be implemented in hardware, software, firmware, or combinations thereof. The property management module 500 may include various sub-modules to provide various features and functions. These sub-modules may include one or more of an object selection module 502, value establishment module 504, inheritance module 506, override module 508, and presentation module 510. The presentation module 510 may include one or more of a format module 512, icon module 514, label module 516, and link module 518. The sub-modules are presented by way of example and are not intended to represent an exhaustive list of sub-modules that may be included in the property management module 500. The property management module 500 may include more or fewer sub-modules than those illustrated, or the functionality of the sub-modules may be organized differently.

The object selection module 502 may enable an administrator to select an object 300 in the object hierarchy 200 and the value establishment module 504 may enable the user to establish property values for the selected object 300. The inheritance module 506 may enable these property values to be inherited by lower-level objects in the object hierarchy 200. The override module 508, by contrast, may enable the inheritance of property values from higher-level objects to be overridden. For example, the override module 508 may enable a property value to be set locally that overrides a property value inherited from a higher-level object. When a property value is set locally, the property value may be isolated to the object 300 where it was set, or may propagate down to lower-level objects beneath the object 300.

When an object 300 is selected, the presentation module 510 may provide means for presenting properties and associated property values associated with the object 300. For example, properties and associated property values may be presented in a property sheet 400 like that illustrated in FIG. 4. A format module 512 may organize the properties and associated property values in a desired format, such as the table 402 previously described. In doing so, the format module 512 may, in certain embodiments, provide space for icons 408 and/or labels 410 next to the property values.

When a property value is inherited from a higher-level object, the icon module 514 may present an icon 408 adjacent to or in association with the property value. This icon 408 may represent the level in the object hierarchy 200 from which the property value was inherited. Similarly, the label module 516 may present a label 408 adjacent to or in association with the property value. This label 410 may indicate the actual object 300 in the object hierarchy 200 from which the property value was inherited. In certain embodiments, the label 410 may include a name or other identifier associated with the higher-level object 300. In certain embodiments, a link module 518 may create a link between the label 410 and a property sheet 400 of the higher-level object 300. This may enable the property value to be changed at the higher-level object 300 as opposed to locally at the down-level object 300.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for indicating property inheritance in object hierarchies, the method comprising:
enabling a user to select an object in an object hierarchy;
displaying a property sheet showing property values for the selected object;
showing, on the property sheet, a property value that is inherited from an object upstream from the selected object;
providing, on the property sheet, an icon indicating a source level in the object hierarchy from which the property value is inherited; and
providing, on the property sheet, a label indicating a source object in the object hierarchy from which the property value is inherited.

2. The method of claim 1, further comprising linking the label to a property sheet associated with the source object.

3. The method of claim 2, further comprising displaying the property sheet associated with the source object when the label is clicked with a mouse pointer.

4. The method of claim 1, further comprising displaying the label adjacent to the icon.

5. The method of claim 1, further comprising integrating, into the label, a name associated with the source object.

6. The method of claim 1, wherein levels in the object hierarchy include datacenters, host clusters, host systems, and virtual machines.

7. The method of claim 1, further comprising presenting the property values in a table on the property sheet.

8. A computer program product for indicating property inheritance in object hierarchies, the computer program product comprising a computer-readable storage medium having computer-usable program code embodied therein, the computer-usable program code configured to perform the following when executed by at least one processor:
enable a user to select an object in an object hierarchy;
display a property sheet showing property values for the selected object;
show, on the property sheet, a property value that is inherited from an object upstream from the selected object;
provide, on the property sheet, an icon indicating a source level in the object hierarchy from which the property value is inherited; and
provide, on the property sheet, a label indicating a source object in the object hierarchy from which the property value is inherited.

9. The computer program product of claim 8, wherein the computer-usable program code is further configured to link the label to a property sheet associated with the source object.

10. The computer program product of claim 9, wherein the computer-usable program code is further configured to display the property sheet associated with the source object when the label is clicked with a mouse pointer.

11. The computer program product of claim 8, wherein the computer-usable program code is further configured to display the label adjacent to the icon.

12. The computer program product of claim 8, wherein the computer-usable program code is further configured to integrate, into the label, a name associated with the source object.

13. The computer program product of claim 8, wherein levels in the object hierarchy include datacenters, host clusters, host systems, and virtual machines.

14. The computer program product of claim 8, wherein the computer-usable program code is further configured to present the property values in a table on the property sheet.

15. A system for indicating property inheritance in object hierarchies, the system comprising:
at least one processor;
at least one memory device operably coupled to the at least one processor and storing instructions for execution on the at least one processor, the instructions causing the at least one processor to:
enable a user to select an object in an object hierarchy;
display a property sheet showing property values for the selected object;
show, on the property sheet, a property value that is inherited from an object upstream from the selected object;
provide, on the property sheet, an icon indicating a source level in the object hierarchy from which the property value is inherited; and
provide, on the property sheet, a label indicating a source object in the object hierarchy from which the property value is inherited.

16. The system of claim 15, wherein the instructions further cause the at least one processor to link the label to a property sheet associated with the source object.

17. The system of claim 16, wherein the instructions further cause the at least one processor to display the property sheet associated with the source object when the label is clicked with a mouse pointer.

18. The system of claim 15, wherein the instructions further cause the at least one processor to display the label adjacent to the icon.

19. The system of claim 15, wherein the instructions further cause the at least one processor to integrate, into the label, a name associated with the source object.

20. The system of claim 15, wherein levels in the object hierarchy include datacenters, host clusters, host systems, and virtual machines.
